(19) United States
(12) Patent Application Publication
(10) Pub. No.: US 2009/0167608 A1
(43) Pub. Date: Jul. 2, 2009

(54) Soft plate antenna

(76) Inventor: Chang-Hai Chen, Hsin Chu City (TW)

Correspondence Address: Chen, Chang-Hai, P.O. BOX 7-820, Taipei, TW

(21) Appl. No.: 12/005,980

(22) Filed: Dec. 31, 2007

(51) Int. Cl. H01Q 9/04; H01Q 1/38

(52) U.S. Cl. 343/700 MS

(57) ABSTRACT

A soft plate antenna, wherein the soft plate is provided with a conductive line: one end of the conductive line is electrode contact, the other end being the signal transceiving end. With a specially combined structure, the soft plate and soft circuit can be installed by means of twisted and affixed to the interior shell of a wide variety of electronic products and the plate surface can be provided with double-sided adhesive tapes to affix the plate firmly.

### BACKGROUND OF THE INVENTION

(a) Field of the Invention

The present invention is related to a soft plate antenna, wherein the soft plate is provided with a conductive line: one end of the conductive line is electrode contact, the other end being the signal transceiving end. With a specially combined structure, the soft plate and soft circuit can be installed by means of being twisted and affixed to the interior shell of a wide variety of electronic products and the plate surface can be provided with double-sided adhesive tapes to affix the plate firmly.

(b) Description of the Prior Art

Electronic signal transmission structures have been used extensively in mobile phones, video cameras, cameras, etc. However, early technologies generally adopted telescopic antenna to obtain long transmission distance, but required large space to store the antenna due to large size. The early technologies were then replaced by the new infrared point-to-point straight-line transmission technology, which is gradually abandoned as the use of the structure is restricted by the terrain. Subsequently, the Bluetooth technology brings about obstruction-free transmission to reduce the size of the electronic product(s), but still has the deficiency of short transmission distance. In recent days, the hard circuit board antenna has been installed directly, which still occupies a large space although the transmission distance is increased and needs to be downsized.

### SUMMARY OF THE INVENTION

The primary purpose of the present invention is to provide a soft plate antenna, wherein the soft plate is provided with a conductive line, one end of which is the electrode contact; the other end is the signal transceiving end to provide various electronic products with the signal transmission function.

The secondary purpose of this invention is to provide a soft plate antenna, wherein the soft plate and soft circuit can be installed by means of being twisted and affixed to the interior shell of a wide variety of electronic products with a specially combined structure.

Another purpose of this invention is to provide a soft plate antenna, wherein the surface of the plate is provided with double-sided adhesive tapes to affix the plate firmly and provide safe and rapid operations.

### BRIEF DESCRIPTION OF THE DRAWINGS

FIG. 1 is a view of preferred embodiment of the present invention.

FIG. 2 is a 3D drawing of the structure of the present invention.

FIG. 3 is a schematic view showing that the double-sided adhesive tapes are affixed inside the shell in the present invention.

FIG. 4 is a schematic view showing that the soft plate can be twisted and affixed freely in the present invention.

### DETAILED DESCRIPTION OF THE PREFERRED EMBODIMENTS

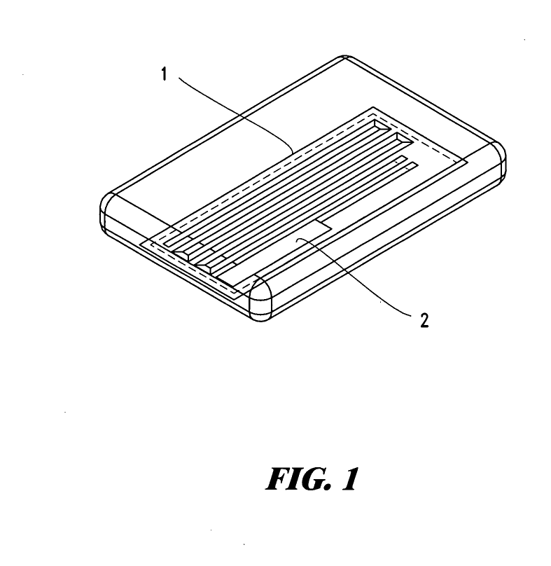

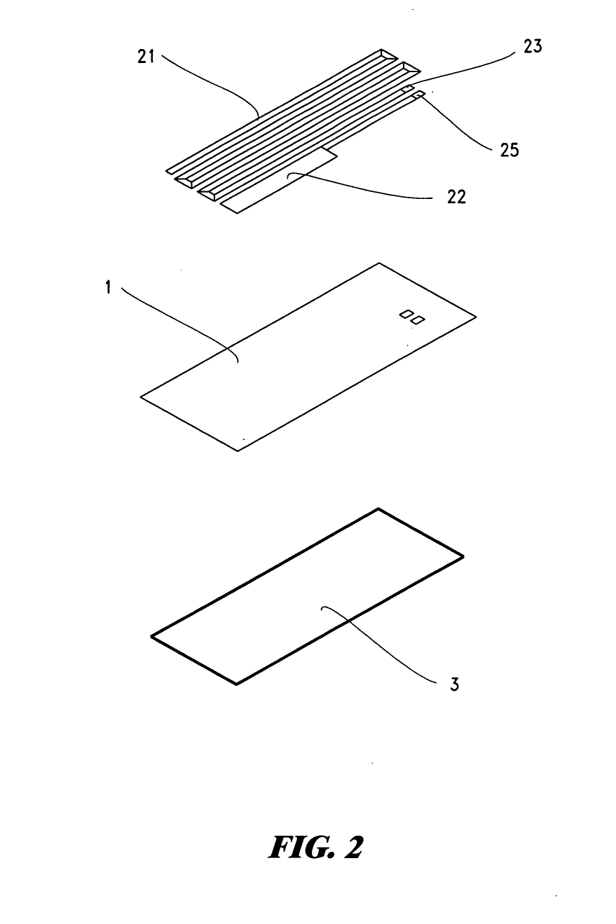

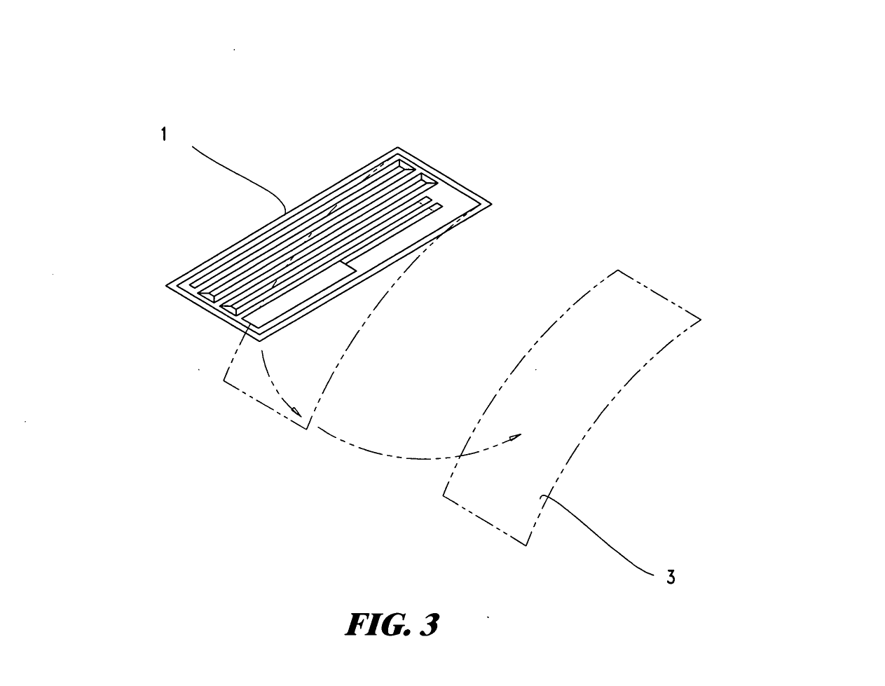

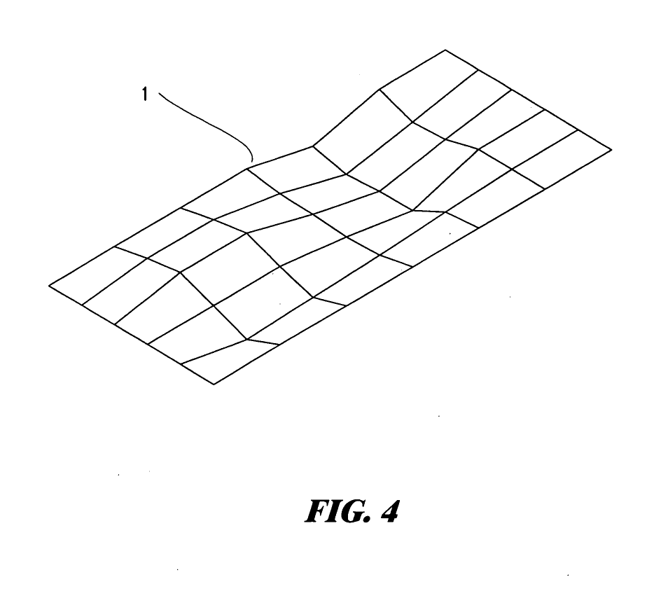

Referring to FIG. 1 through FIG. 4, the present invention is related to a soft plate antenna, comprising soft plate 1 being thin plastic plate, conductive line 2 being conductive metal affixed on the surface of said conductive line 2, one end of said conductive line being electrode contacts 21 and 22, the other end being signal transceiving ends 23 and 25.

In one embodiment of this invention, with the specially combined structure of soft plate 1 and soft circuit 2, the soft plate antenna can be installed by means of twisted and affixed to the interior shell of a wide variety of electronic products. The surface of the plate can be provided with double-sided adhesive tapes 3 to affix the antenna to the interior shell firmly and electrode contacts 21 and 22 provide signal end connection of the electronic products to provide safe and rapid operations.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claimed:

1. A soft plate antenna, comprising a soft plate and conductive line, wherein:
the soft plate is a thin plastic plate;
the conductive line is conductive metal affixed on the surface of the conductive line: one end of which is electrode contact, the other end being the signal transceiving end. With a specially combined structure, the soft plate and soft circuit can be installed by means of being twisted and affixed to the interior shell of a wide variety of electronic products to provide safe and rapid operations.

2. A soft plate antenna according to claim 1, wherein the surface of the soft plate is provided with double-sided adhesive tapes to affix the plate firmly.
